(19) United States
(12) Patent Application Publication
(10) Pub. No.: US 2015/0002303 A1
(43) Pub. Date: Jan. 1, 2015

(54) SYSTEM TO DISPLAY REMAINING PAYLOAD WEIGHT FOR A TRUCK

(71) Applicant: Caterpillar Inc., Peoria, IL (US)

(72) Inventors: Robert W. Stanley, Chillicothe, IL (US); Jeffery E. Buettner, East Peoria, IL (US); Alexander T. Rennemann, Peoria, IL (US)

(73) Assignee: Caterpillar Inc., Peoria, IL (US)

(21) Appl. No.: 14/485,843

(22) Filed: Sep. 15, 2014

(51) Int. Cl. G08B 5/36; G01G 19/08; B65G 67/04

(52) U.S. Cl. CPC G08B 5/36; B65G 67/04; G01G 19/08
USPC 340/666

(57) ABSTRACT

A system to display remaining payload weight for a truck is provided. The system comprises one or more sensors located on a machine, a computing module operably coupled to the one or more sensors, and a comparing module operably coupled to the computing module. Further, the system includes a monitor coupled to the comparing module and the computing module. The monitor displays a remaining payload weight for the truck, with color. A first background color is used when the remaining payload weight is above a tolerance range. A second background color is used when the remaining payload weight is within the tolerance range. A third background color is used when the remaining payload weight is below the tolerance range.

### TECHNICAL FIELD

The present disclosure relates to machines. More particularly, the present disclosure relates to a system to display remaining payload weight for a truck.

### BACKGROUND

Off-highway machines, such as wheel loaders, wheel excavators, track loaders, track excavators, backhoe loaders, forestry machines, and the like, are commonly used in material moving applications. Material moving applications may include construction, demolition, mining, quarrying, stockpiling, forestry, waste processing, and the like. To effectively accomplish the material moving applications, the machines are typically outfitted with hydraulically-powered work implements, such as buckets, forks, grapples, and other implements known in the art. The machine may include a prime mover, such as a diesel engine, gasoline engine, or gaseous fuel-powered engine, to drive one or more hydraulic pumps that provide hydraulic power to the work implement. Hydraulically-powered work implements are typically controlled based on an actuation position of an operator interface device, such as a joystick, a pedal, and other device known in the art.

In a typical material moving operation, a payload carried by the work implement of the machine, is offloaded into a dump bed of a truck. During operation of the machine, information related to a payload weight carried by the work implement, a truck target payload weight, and a truck remaining payload weight, may be important for many reasons, such as favorable work environment and work efficiency.

U.S. Pat. No. 4,921,578 describes an apparatus that represents a truck target payload weight to be carried by the dump truck, wherein the truck target payload weight is being measured using a load meter of the type mounted on the dump truck. The apparatus includes a display unit to represent an estimated truck target payload weight to be carried by the dump truck and the estimated truck current payload weight for a current payload delivery by the work implement. It is desirable to display the payload weight of the work implement along with the truck remaining payload weight and the truck current payload weight, to the operator over the entire range of motion of the work implement.

### SUMMARY OF THE INVENTION

The present disclosure relates to a system to display a remaining payload weight for a truck. The system is disposed on a machine which loads the truck.

In accordance with the present disclosure, the system comprises one or more sensors, a computing module, a comparing module, and a monitor. The computing module is operably coupled to the one or more sensors located on the machine. The computing module is configured to determine a current payload weight of the truck and the remaining payload weight for the truck. The remaining payload weight is calculated based on a truck target payload weight and the current payload weight of the truck. A tolerance range for the remaining payload weight of the truck is also determined. The comparing module is operably coupled to the computing module. The comparing module is configured to compare the calculated remaining payload weight with the tolerance range to generate a comparison output. The monitor is operably coupled to the computing module and the comparing module. The monitor includes a truck ID widget and a truck target payload weight widget. Based on the comparison output, the monitor displays the remaining payload weight with a first background color when the remaining payload weight is above the tolerance range. The monitor displays the remaining payload weight with a second background color different from the first background color when the remaining payload weight is within the tolerance range. Further, the monitor displays the remaining payload weight with a third background color different from the first background color and the second background color, when the remaining payload weight is below the tolerance range.

### BRIEF DESCRIPTION OF THE DRAWINGS

FIG. 1 illustrates a loading operation between a machine and a truck, in accordance with the concepts of the present disclosure;

FIG. 2 illustrates a side view of the exemplary machine of FIG. 1, in accordance with the concepts of the present disclosure;

FIG. 3 illustrates a system to display a remaining payload weight for the truck of FIG. 1, in accordance with the concepts of the present disclosure;

FIG. 4 illustrates a monitor of the system of FIG. 2, in accordance with the concepts of the present disclosure;

FIG. 5 illustrates the monitor of FIG. 3, in accordance with the concepts of the present disclosure;

FIG. 6 illustrates the monitor of FIG. 3 when the truck is in overload condition, in accordance with the concepts of the present disclosure; and

FIG. 7 illustrates a flowchart for a method to display the remaining payload weight for the truck of FIG. 1, in accordance with the concepts of the present disclosure.

### DETAILED DESCRIPTION

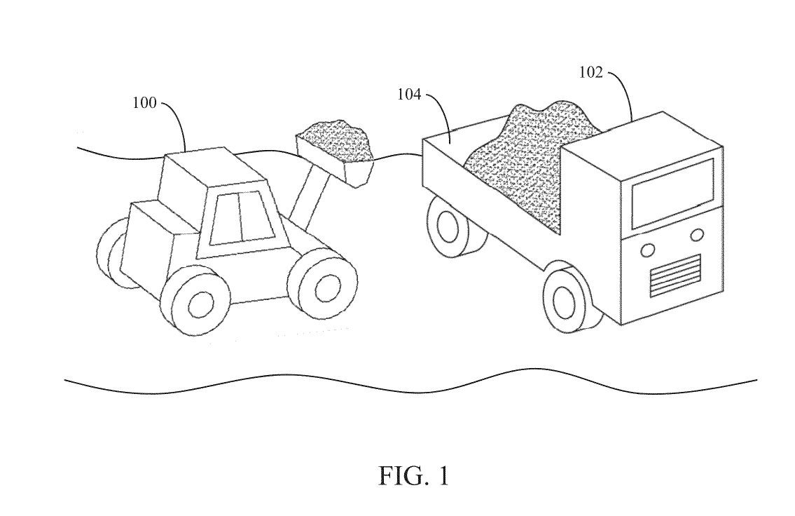

Referring to FIG. 1, there is shown a loading operation. The loading operation is performed by a machine 100, at a loading site. The machine 100 may be a mobile vehicle that performs some type of operation associated with an industry, such as mining, construction, farming, and/or other industry. The machine 100 may collect a payload from the loading site and may move to the location of a truck 102, to dump the payload. The truck 102 may be a dump truck, an articulated truck, a concrete transport truck, a ballast truck, a garbage truck, a hauling vehicle, and/or other loading vehicle known in the industry. The truck 102 may include a dump body 104 to receive the payload offloaded by the machine 100. Typically, the truck 102 is in proximity of the machine 100, during the loading operation.

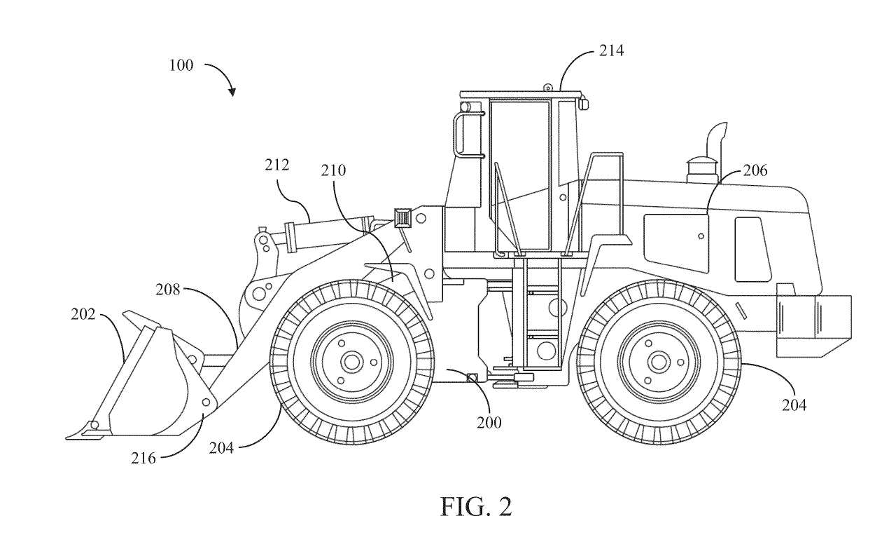

Referring to FIG. 2, there is shown the exemplary machine 100. The machine 100 may be a material-moving vehicle, such as a wheel loader (depicted), excavator, backhoe, and/or the like. The machine 100 may include a frame 200, an implement 202, one or more traction devices 204, a power source 206, a lift arm 208, one or more lift cylinders 210, a tilt cylinder 212, and an operator station 214.

The frame 200 may include any structural member or assembly of members that supports movement of the machine 100. The frame 200 may be supported on the one or more traction devices 204. The frame 200 may embody a stationary base that connects the one or more traction devices 204 (such as wheels) to the power source 206. The traction devices 204 may be powered and driven by the power source 206, to propel the machine 100 in a desired direction for operation. The power source 206 may be an engine, such as a diesel engine, a gasoline engine, a gaseous fuel-powered engine, a natural gas engine, or other engine known to one skilled in the art. The power source 206 may also embody other sources of power, such as a fuel cell, a power storage device, or other source of power. The power source 206 may be supported by the frame 200 and configured to produce mechanical and/or electrical power output used to drive operation of a steering component (not shown) and the implement 202.

The implement 202 may embody a specialized device, such as a bucket, a shovel, or the like, which is used in the performance of a particular task. The implement 202 may be connected to the frame 200 via the lift arm 208, and may be movable relative to the frame 200. The lift arm 208 is actuated by the one or more lift cylinders 210, which are coupled to the frame 200 at one end and to the lift arm 208 at a second end. The lift arm 208 is pivotally coupled to the implement 202, via a coupler 216. The implement 202 is shown lifted by the one or more lift cylinders 210 and tilted by the tilt cylinder 212. It is also contemplated that the implement 202 may alternatively or additionally be configured to pivot, rotate, slide, swing, or move in other ways relative to the frame 200, if desired.

The implement 202 may be operated from the operator station 214. The operator station 214 may be supported on the frame 200 and may include one or more operator interface devices (not shown), such as a steering wheel, single or multi-axis joysticks, switches, knobs, or other known devices that are located proximal to an operator seat. The operator interface devices (not shown) may be proportional-type controllers, which are configured to generate control signals indicative of a desired position, force, velocity, and/or acceleration of the lift cylinder 210 and the tilt cylinder 212, which in turn, operate the implement 202.

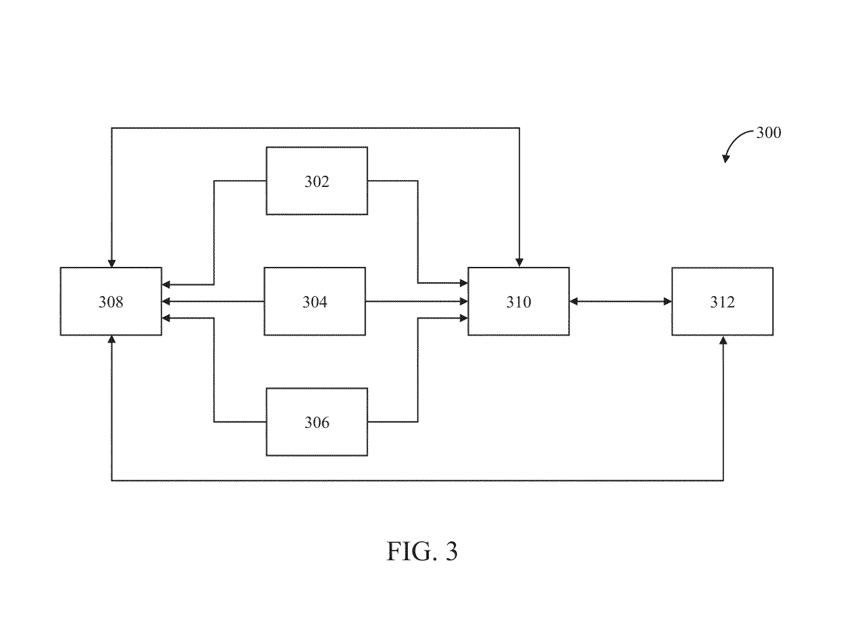

Referring to FIG. 3, there is shown a system 300 to display remaining payload weight for the truck 102 (shown in FIG. 1). The system 300 may include a lift arm sensor 302, a lift cylinder rod-end sensor 304, a lift cylinder head-end sensor 306, a computing module 308, a comparing module 310, and a monitor 312. The lift arm sensor 302 may use a rotary sensor, an optical sensor, or an encoder. The lift arm sensor 302 measures a lift position of the lift arm 208 when it senses a rotation of the lift arm 208. Thereafter, the lift arm sensor 302 sends a position signal corresponding to the lift position, to the computing module 308.

The lift cylinder 210 uses at least two pressure sensors, that is, the lift cylinder rod-end sensor 304 and the lift cylinder head-end sensor 306. The lift cylinder rod-end sensor 304 and the lift cylinder head-end sensor 306, respectively, are mounted on rod-end and head-end of the lift cylinder 210. The lift cylinder rod-end sensor 304 measures the pressure within the rod-end of the lift cylinder 210 at the lift position, and provides a first pressure signal to the computing module 308. Similarly, the lift cylinder head-end sensor 306 measures the pressure within the head end of the lift cylinder 210 at the lift position, and provides a second pressure signal to the computing module 308.

Each of the computing module 308 and the comparing module 310 may be an electronic control module (ECM), electronic control unit (ECU), or the like. Each of the computing module 308 and the comparing module 310 includes at least one processor, volatile and non-volatile memory, input and output ports, network and communication ports, and/or the like. Each of the computing module 308 and the comparing module 310 is operably coupled to each of the monitor 312, the lift cylinder rod-end sensor 304, the lift cylinder head-end sensor 306, the lift arm sensor 302, and at least one of the operator interface devices (not shown). Generally, the computing module 308 and the comparing module 310 may be coupled to one or more data networks on board the machine 100. The computing module 308 and the comparing module 310 may be coupled to one or more additional, on board modules, such as an operator station ECM, an information ECM, and the like.

The computing module 308 and the comparing module 310 are operably coupled to each other. The computing module 308 is operably coupled to each of the monitor 312, the lift cylinder rod-end sensor 304, the lift cylinder head-end sensor 306, the lift arm sensor 302, and at least one of the operator interface devices (not shown) disposed on the machine 100. The computing module 308 generates an output that is displayed via the monitor 312. Based on the communication of data with the lift cylinder rod-end sensor 304, the lift cylinder head-end sensor 306, the lift arm sensor 302, and at least one of the operator interface devices (not shown), the computing module 308 determines a current payload weight, a truck target payload weight, and a remaining payload weight.

Further, the computing module 308 also determines a tolerance range for the remaining payload weight, to depict an underload condition or an overload condition of the truck 102 (shown in FIG. 1). In can be contemplated that a loading operation taking place with the remaining payload weight within, below, or above the tolerance range, may be referred as the loading operation in the tolerance range, the overload condition, or the underload condition, respectively. The tolerance range includes an underload threshold and an overload threshold. The underload threshold is the remaining payload weight to be loaded on the truck 102 (not shown), for the loading operation to enter the tolerance range. This implies that any remaining payload weight equal to or lesser than the underload threshold is in the tolerance range. For the remaining payload weight greater than the underload threshold, the loading operation is said to be in the underload condition. The underload threshold may be a first pre-determined value of the truck target payload weight. The first pre-determined value may be dependent on the type of the machine and the application it is operating in.

The overload threshold is the remaining payload weight to be loaded on the truck 102 (not shown), beyond which the loading operation exits the tolerance range. This implies that any remaining payload weight equal to or greater than the overload threshold is in the tolerance range. For the remaining payload weight lesser than the overload threshold, the loading operation exits the tolerance range and is said to be in the overload condition. The overload threshold may be a second pre-determined value of the truck target payload weight. The second pre-determined value may be dependent on the type of the machine and the application it is operating in. The underload threshold and the overload threshold are dependent on the operation and requirements. Further, the underload threshold and the overload threshold may be user-defined or factory values. The computing module 308 may factor out various detrimental effects, such as noise, hydraulic fluid temperature, linkage and pin friction, and the like.

The computing module 308 that controls communication with the comparing module 310, transmits the computed data to the comparing module 310. Upon determination of the remaining payload weight, the comparing module 310 compares the calculated remaining payload weight with the tolerance range, to generate a comparison output. The comparing module 310 then sends the comparison output to be displayed via the monitor 312.

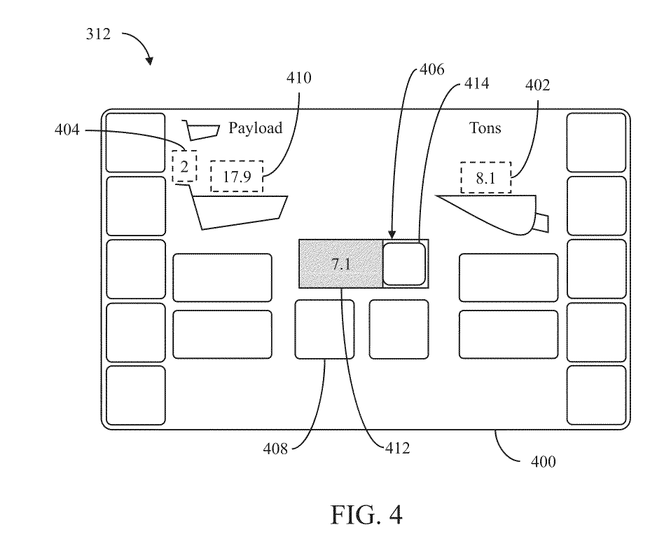

Referring to FIG. 4, there is shown the monitor 312 of the system 300 for the machine 100. As depicted in FIGS. 2 and 3, the computing module 308 sends one or more signals, directly or indirectly, to the monitor 312 to be displayed. The monitor 312 includes a screen 400, which may be a touch screen that presents graphical user interface (GUI) elements related to the system 300. The screen 400 may include an implement payload weight widget 402, a pass count icon 404, a truck weight widget 406, a truck ID selection button 408, and a truck current payload weight widget 410. A graphical representation of the implement 202, such as a bucket icon, may also be provided on the monitor 312. The implement payload weight widget 402 displays the implement payload weight as a number, such as, “12.0”, on the monitor 312.

The screen 400 is equipped with the truck weight widget 406, which includes a remaining payload weight icon 412 and a manual truck target selection button 414. The manual truck target selection button 414 allows an operator to enter the truck target payload weight as desired. The remaining payload weight icon 412 depicts the remaining payload weight for the truck 102 (shown in FIG. 1) displayed with a colored background. The color of the background may vary depending on the remaining payload weight and the tolerance range.

In an example, the system 300 operates for the truck target payload weight of 25.0 tons. The screen 400 shows the implement payload weight in the implement payload weight widget 402, as “8.1”, as determined by the computing module 308. Also, a current number of dumps executed by the implement 202, used to load the truck 102 (shown in FIG. 1) is displayed in the pass count icon 404, as “2”. The current payload weight for the truck 102 (shown in FIG. 1) is depicted in the truck current payload weight widget 410, as “17.9”, as determined by the computing module 308. The remaining payload weight is depicted in the remaining payload weight icon 412 as “7.1”, which is calculated as the difference between the target payload weight of 25 tons and the current payload weight of 17.9 tons (as depicted in the truck current payload weight widget 410). The remaining payload weight is displayed in the truck weight widget 406 with a first background color. The first background color of the truck weight widget 406 is in accordance with the comparison output of the comparing module 310. The remaining payload weight icon 412 has the first background color when the comparing module 310 determines that the remaining payload weight (7.1 tons) is above the tolerance range. In other words, the remaining payload weight (7.1 tons) is greater than the underload threshold indicating that the truck 102 (shown in FIG. 1) is in the underload condition.

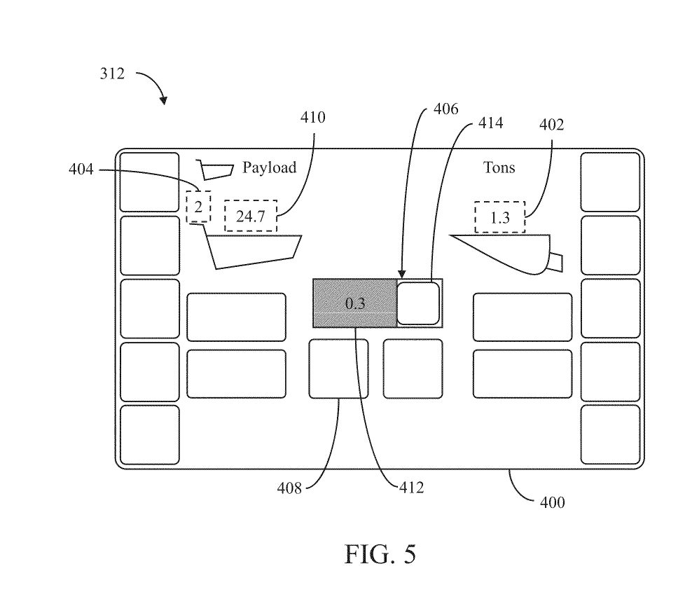

Referring to FIG. 5, there is shown the screen 400 of the monitor 312 of the system 300. For the same example as described for FIG. 4, the system 300 operates with the truck target payload weight of 25.0 tons. The screen 400 shows the implement payload weight in the implement payload weight widget 402, as “1.3”, as determined by the computing module 308. Also, the current number of dumps executed by the implement 202, used to load the truck 102 (shown in FIG. 1) is displayed in the pass count icon 404, as “2”. The current payload weight for the truck 102 (shown in FIG. 1) is depicted in the truck current payload weight widget 410, as “24.7”, as determined by the computing module 308. The truck current payload weight widget 410 displays the current payload weight which has increased from 17.9 tons (depicted in FIGS. 4) to 24.7 tons, because the payload of 6.8 tons (24.7 tons−17.9 tons=6.8 tons) is being delivered by the implement 202 to the truck 102 (shown in FIG. 1). Likewise, the remaining payload weight is depicted in the remaining payload weight icon 412 as “0.3”, which has decreased from 7.1 tons (depicted in FIGS. 4) to 0.3 tons. The remaining payload weight is calculated as the difference between the target payload weight of 25 tons and the current payload weight of 24.7 tons (as depicted in the truck current payload weight widget 410). The remaining payload weight is displayed in the truck weight widget 406 with a second background color. The second background color of the truck weight widget 406 is in accordance with the comparison output of the comparing module 310. The remaining payload weight icon 412 has the second background color when the comparing module 310 determines that the remaining payload weight (0.3 tons) is within the tolerance range.

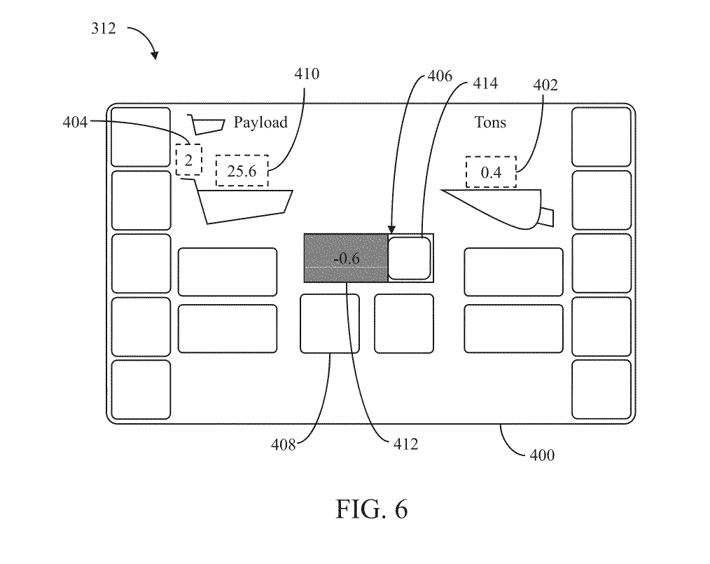

Referring to FIG. 6, there is shown the screen 400 of the monitor 312 of the system 300. For the same example as described for FIG. 4 and FIG. 5, the system 300 operates for the truck target payload weight of 25.0 tons. The screen 400 shows the implement payload weight in the implement payload weight widget 402, as, “0.4”, as determined by the computing module 308. Also, the current number of dumps executed by the implement 202, used to load the truck 102 (shown in FIG. 1) is displayed in the pass count icon 404, as “2”. The current payload weight for the truck 102 (shown in FIG. 1) is depicted in the truck current payload weight widget 410 as, “25.6” as determined by the computing module 308. The truck current payload weight widget 410 displays the current payload weight which has increased from 24.7 tons (depicted in FIG. 5) to 25.6 tons, because the payload of 0.9 tons (25.6 tons−24.7 tons=0.9 tons) is being delivered by the implement 202 to the truck 102 (shown in FIG. 1). Likewise, the remaining payload weight is depicted in the remaining payload weight icon 412 as “−0.6”, which has decreased from 0.3 tons (depicted in FIG. 4) to −0.6 tons. The remaining payload weight is calculated as the difference between the target payload weight (25 tons) and the current payload weight (25.6 tons as depicted in the truck current payload weight widget 410). However, in this case, the remaining payload weight is the excess payload weight by which the current payload weight has exceeded the target payload weight (25 tons). Here, the remaining payload weight is depicted with a “−” (negative) sign to show that the remaining payload weight (−0.6) is the excess payload weight. The remaining payload weight is displayed with a third background color in the truck weight widget 406. The third background color of the truck weight widget 406 is in accordance with the comparison output of the comparing module 310. The remaining payload weight icon 412 has the third background color when the comparing module 310 determines that the remaining payload weight (−0.6 tons) is beyond the tolerance range, indicating that the truck 102 (shown in FIG. 1) is in the overload condition. In other words, the remaining payload weight (−0.6 tons) is less than the overload threshold.

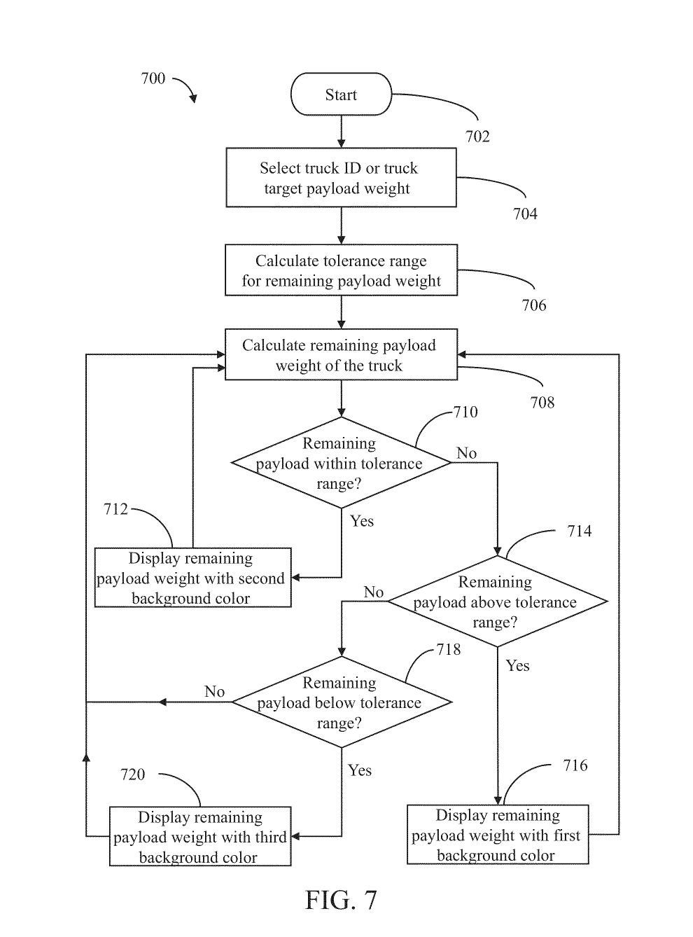

Referring to FIG. 7, there is shown a flowchart for a method 700 to display the remaining payload weight for the truck 102 (shown in FIG. 1). The method 700 begins with step 702 and proceeds to step 704.

At step 704, the operator may select the truck target payload weight, on the screen 400 of the monitor 312. The operator may select the truck ID via the truck ID selection button 408. Alternatively, the operator may also enter the truck target payload weight via the manual truck target selection button 414. The method 700 proceeds to step 706.

At step 706, the computing module 308 determines the tolerance range for the remaining payload weight of the truck 102 (shown in FIG. 1). The method 700 proceeds to step 708.

At step 708, the computing module 308 calculates the remaining payload weight, based on the truck target payload weight and the payload delivery. The method 700 proceeds to step 710.

At step 710, the comparing module 310 compares the calculated remaining payload weight with the tolerance range and generates the comparison output. If the remaining payload weight is within the tolerance range, then the method 700 proceeds to step 712. If the remaining payload weight is not within the tolerance range, then the method 700 proceeds to step 714.

At step 712, the remaining payload weight is displayed with the second background color in the remaining payload weight icon 412. In an embodiment, the second background color may be green. The method 700 returns to step 708.

At step 714, the comparing module 310 compares the calculated remaining payload weight with the tolerance range to determine whether the remaining payload weight is above the tolerance range. If the remaining payload weight is above the tolerance range, then the method 700 proceeds to step 716. If the remaining payload weight is not above the tolerance range, then the method 700 proceeds to step 718.

At step 716, the remaining payload weight is displayed with the first background color in the remaining payload weight icon 412. In an embodiment, the first background color may be grey. The method 700 returns to step 708.

At step 718, the comparing module 310 compares the calculated remaining payload weight with the tolerance range and generates the comparison output, to determine whether the remaining payload weight is below the tolerance range. If the remaining payload weight is below the tolerance range, the method 700 proceeds to step 720. If the remaining payload weight is not below the tolerance range, then the method 700 returns to step 708.

At step 720, the remaining payload weight is displayed with the third background color in the remaining payload weight icon 412. In an embodiment, the third background color may be red. The method 700 returns to step 708.

### INDUSTRIAL APPLICABILITY

In operation, the operator initiates a dump cycle to fill a payload in the truck 102 (shown in FIG. 1), via the implement 202 of the machine 100. To initiate the system 300 to display the remaining payload weight for the truck 102 (shown in FIG. 1), the operator may enter commands or input on the monitor 312, thereby sending signals to the computing module 308. The operator selects the truck target payload weight via at least one of the truck ID selection button 408 or the manual truck target selection button 414. Based on the actuation by the operator, the computing module 308 receives the signal related to the truck target payload weight. Further, the computing module 308 receives the first pressure signal and the second pressure signal, respectively, from the lift cylinder rod-end sensor 304, and the lift cylinder head-end sensor 306. The computing module 308 then determines the difference between values of the first pressure signal and the second pressure signal, for the lift position. The computing module 308 calculates an implement payload weight based on the pressure difference, by use of a pre-determined algorithm or a pre-determined formula stored in the memory of the computing module 308. The implement payload weight is displayed on the screen 400 by the implement payload weight widget 402.

In another embodiment, the computing module 308 determines the implement payload weight by measuring a deflection of the lift arm 208, based on the position signal from the lift arm sensor 302. In a further embodiment, the computing module 308 determines the implement payload weight by measuring a strain of the lift arm 208, using a strain gauge.

The computing module 308 determines the current payload weight for the truck 102 (shown in FIG. 1) as the payload delivery by the machine 100. The payload delivery may be calculated based on the number of dumps by the implement 202 and the implement payload weight. The number of dumps is depicted on the screen 400 by the pass count icon 404. On receipt of the above mentioned data of the current payload weight and the truck target payload weight, the computing module 308 then determines a remaining payload weight for the truck 102 (shown in FIG. 1). The remaining payload weight is determined as a difference between the truck target payload weight and the current payload weight. The remaining payload weight is displayed on the screen 400 by the remaining payload weight icon 412 of the truck weight widget 406.

Further, the computing module 308 calculates the tolerance range for the remaining payload weight of the truck 102 (shown in FIG. 1). The computing module 308 determines the underload condition or the overload condition of the truck 102 (shown in FIG. 1), based on the target payload weight. Accordingly, the remaining payload weight is displayed in the remaining payload weight icon 412 with the background of a pre-defined color. For example, in the system 300 having the tolerance range with the underload threshold as 15 percent of the truck target payload weight and the overload threshold as 5 percent of the truck target payload weight. In this case, if the current payload weight of the truck 102 (shown in FIG. 1) is computed as 90 percent of the truck target payload weight and the remaining payload weight as 10 percent of the truck target payload weight, (which indicates that the remaining payload weight is within the tolerance range) the remaining payload is displayed with the second background color in the remaining payload weight icon 412.

The disclosed system 300 and method 700, advantageously display the implement payload weight to the operator of a machine, throughout the entire range of motion of the implement 202. The disclosed system 300 provides an indication of tolerance and remaining payload weight, which allows the operator to work more efficiently, thereby improving productivity, reducing fuel and maintenance costs, and the like. A machine with a payload-bearing implement 202, may benefit from various aspects of this disclosure. Also, during dumping operations, the operator may find it inconvenient to numerically interpret the remaining payload weight, so as to extrapolate the overload conditions or under-load conditions. Display of the remaining payload weight with the pre-defined background color allows the operator to infer the loading state of the truck 102 (shown in FIG. 1).

The many features and advantages of the disclosure are apparent from the detailed specification, and, thus, it is intended by the appended claims to cover all such features and advantages of the disclosure which fall within the true spirit and scope thereof. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A system disposed on a machine for displaying remaining payload weight for a truck being loaded by the machine, the system comprising:
one or more sensors located on the machine;
a computing module operably coupled to the one or more sensors and configured to:
determine a current payload weight of the truck;
determine a remaining payload weight for the truck, wherein the remaining payload weight is calculated based on a truck target payload weight and the current payload weight; and
determine a tolerance range for the remaining payload weight of the truck;
a comparing module operably coupled to the computing module and configured to compare the calculated remaining payload weight with the tolerance range and generate a comparison output; and
a monitor coupled to the computing module and the comparing module, the monitor adapted to:
display the remaining payload weight with a first background color when the remaining payload weight is above the tolerance range, based on the comparison output;
display the remaining payload weight with a second background color different from the first background color when the remaining payload weight is within the tolerance range, based on the comparison output; and
display the remaining payload weight with a third background color different from the first background color and the second background color when the remaining payload weight is below the tolerance range, based on the comparison output.
